(19) United States
(12) Patent Application Publication
(10) Pub. No.: US 2024/0326546 A1
(43) Pub. Date: Oct. 3, 2024

(54) FLUID CONTROL APPARATUS, FUEL CELL VEHICLE AND FLUID CONTROL METHOD

(71) Applicant: Isuzu Motors Limited, Yokohama-shi (JP)

(72) Inventor: Daichi Shibuya, Fujisawa-shi (JP)

(73) Assignee: Isuzu Motors Limited, Yokohama-shi (JP)

(21) Appl. No.: 18/608,135

(22) Filed: Mar. 18, 2024

(30) Foreign Application Priority Data
Mar. 28, 2023 (JP) 2023-050881

(51) Int. Cl. B60H 1/00; B60H 1/14; B60H 1/22; B60L 1/00; B60L 58/32; H01M 8/04007; H01M 8/04029; H01M 8/0432; H01M 8/04746

(52) U.S. Cl. CPC B60H 1/00278; B60H 1/143; B60H 1/2221; B60L 1/003; B60L 58/32; H01M 8/04029; H01M 8/04067; H01M 8/04358; H01M 8/04365; H01M 8/04768; B60H 2001/00307; H01M 2250/20

(57) ABSTRACT

According to one embodiment, a fluid control apparatus includes a heater; a heater core; a fuel cell unit; a radiator; and a controller configured to control circulation of the cooling water in one of a plurality of control modes, the control modes including a first control mode in which the cooling water heated by the heater circulates in a first flow path in which the cooling water passes through the heater, the hater core and the fuel cell unit and circulates, and a second control mode in which the cooling water is circulated in each of a second flow path in which the cooling water passes through the heater and the heater core and circulates, and a third flow path in which the cooling water passes through the fuel cell unit and the radiator and circulates.

### CROSS REFERENCE TO RELATED APPLICATION

This application is based upon and claims the benefit of priority from prior Japanese Patent Application No. 2023-050881, filed Mar. 28, 2023, the entire contents of which are incorporated herein by reference.

### FIELD

The present invention relates generally to a fluid control apparatus including a fuel cell unit using hydrogen as fuel, a fuel cell vehicle, and a fluid control method.

### BACKGROUND

A vehicle that is operated by a fuel cell using hydrogen as fuel is known. There is known a technology in which, in order to radiate heat generated from a fuel cell, cooling water (cooling medium) is circulated to adjust the temperature of an FC (Fuel Cell) stack that is a fuel cell unit including the fuel cell.

In addition, there is known a technology in which, in order to air-condition a vehicle inside (cabin), water heated by using a heater is supplied to a heater core, and heat is radiated into the vehicle inside. Besides, Jpn. Pat. Appln. KOKAI Publication No. 2022-122631 discloses a flow path configuration in which a flow path of cooling water for cooling a fuel cell and a part of a flow path for air-conditioning a vehicle inside are shared.

On the other hand, it is known that the power generation efficiency of a fuel cell lowers in a low-temperature environment. In the prior-art literature, at a time of low temperatures, the heat generation amount of a fuel cell stack (FC stack) is increased and heat is generated, thereby raising the temperature of the fuel cell stack. However, if the fuel cell stack is operated in order to generate heat, the consumption of hydrogen increases, and there is concern that a driving range of a vehicle becomes shorter.

### SUMMARY

According to one embodiment, a fluid control apparatus includes a heater configured to heat cooling water; a heater core configured to be heated by the cooling water that is heated by the heater; a fuel cell unit including a fuel cell; a radiator configured to perform heat exchange with the cooling water; and a controller configured to control circulation of the cooling water in one of a plurality of control modes, the control modes including a first control mode in which the cooling water heated by the heater circulates in a first flow path in which the cooling water passes through the heater, the hater core and the fuel cell unit and circulates, and a second control mode in which the cooling water is circulated in each of a second flow path in which the cooling water passes through the heater and the heater core and circulates, and a third flow path in which the cooling water passes through the fuel cell unit and the radiator and circulates, the third flow path being independent from the second flow path.

A fuel cell vehicle according to an aspect of the present invention includes the above-described fluid control apparatus.

A fluid control method according to another aspect of the present invention is a fluid control method of a fluid control apparatus including a heater configured to heat cooling water, a heater core configured to be heated by the cooling water that is heated by the heater, a fuel cell unit including a fuel cell, and a radiator configured to perform heat exchange with the cooling water, the fluid control method including selecting one of a plurality of control modes, the control modes including a first control mode in which the cooling water heated by the heater circulates in a first flow path in which the cooling water passes through the heater, the hater core and the fuel cell unit and circulates, and a second control mode in which the cooling water is circulated in each of a second flow path in which the cooling water passes through the heater and the heater core and circulates, and a third flow path in which the cooling water passes through the fuel cell unit and the radiator and circulates, the third flow path being independent from the second flow path; and executing a control process of circulation of the cooling water in the selected control mode.

### BRIEF DESCRIPTION OF THE DRAWINGS

FIG. 1 is an explanatory diagram schematically illustrating a configuration of a fuel cell vehicle according to a first embodiment of the present invention.

FIG. 2 is a block diagram schematically illustrating a configuration of the fuel cell vehicle according to the first embodiment.

FIG. 3 is an explanatory diagram illustrating a first control mode of a fluid control apparatus used in the fuel cell vehicle according to the first embodiment.

FIG. 4 is an explanatory diagram illustrating a second control mode of the fluid control apparatus according to the first embodiment.

FIG. 5 is a flowchart illustrating an example of control using the fluid control apparatus according to the first embodiment.

FIG. 6 is an explanatory diagram schematically illustrating a configuration of a fluid control apparatus of a fuel cell vehicle according to a second embodiment of the present invention.

FIG. 7 is an explanatory diagram schematically illustrating a configuration of a fluid control apparatus of a fuel cell vehicle according to a third embodiment of the present invention.

### DETAILED DESCRIPTION

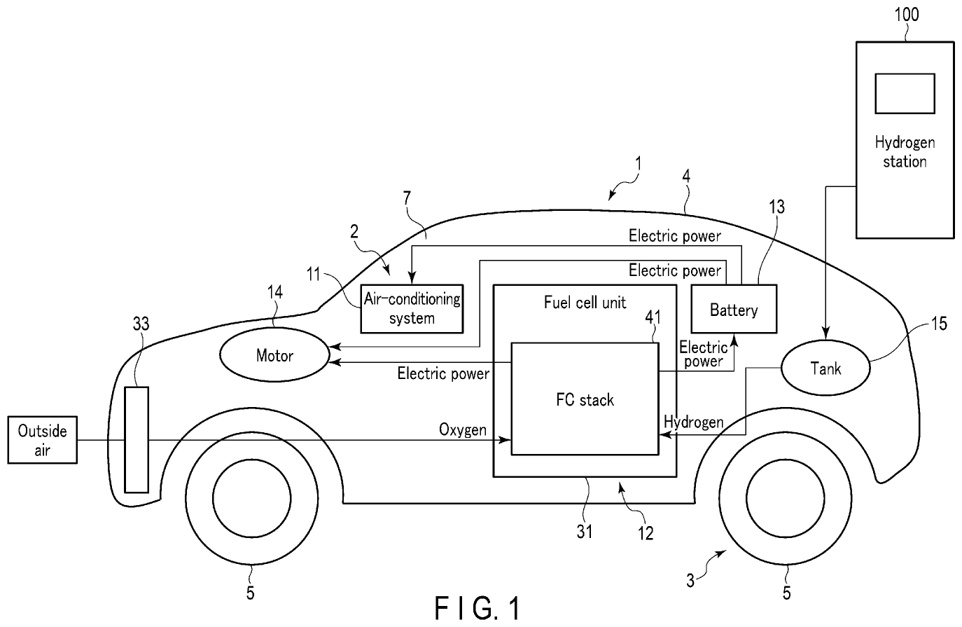

Hereinafter, a configuration of a fluid control apparatus 2 of a fuel cell vehicle 1 according to a first embodiment of the present invention is described with reference to FIG. 1 to FIG. 5.

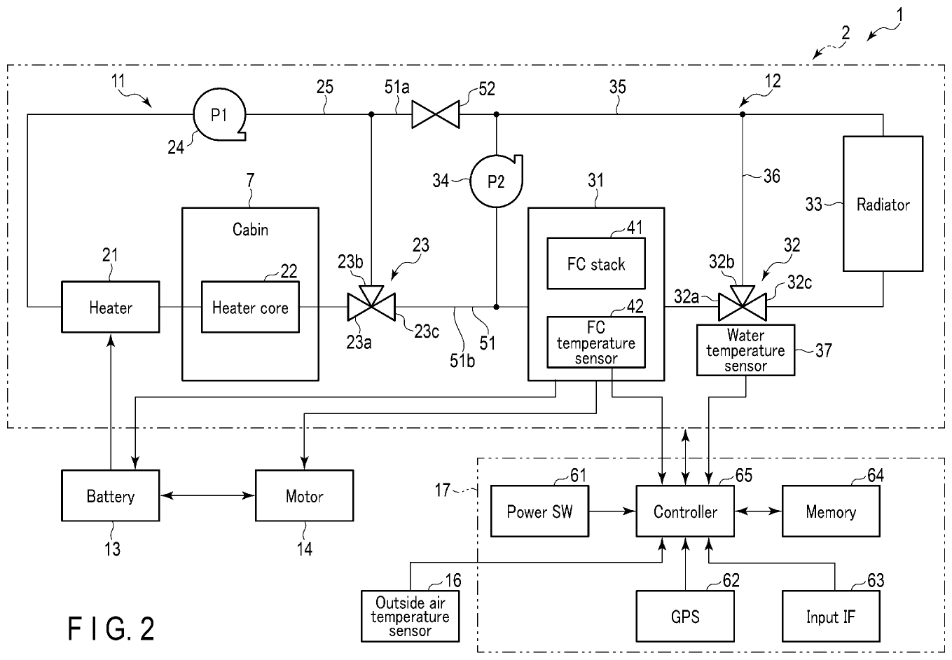

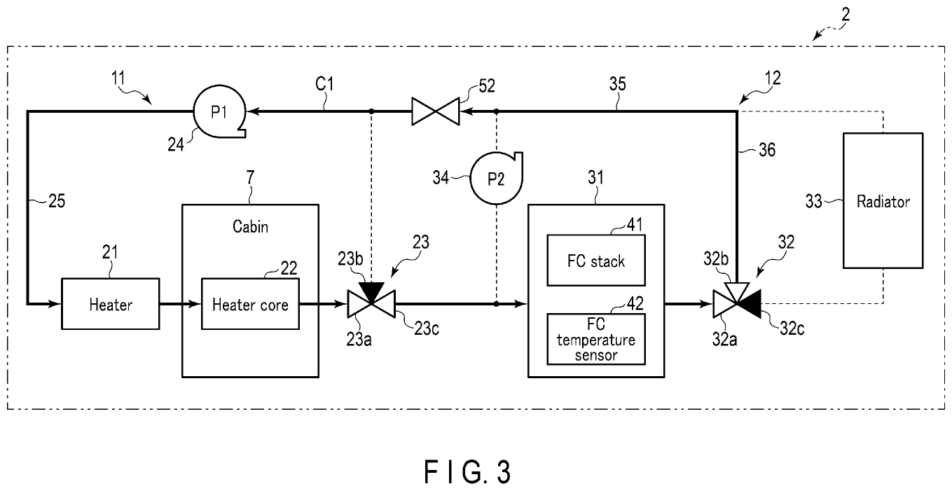

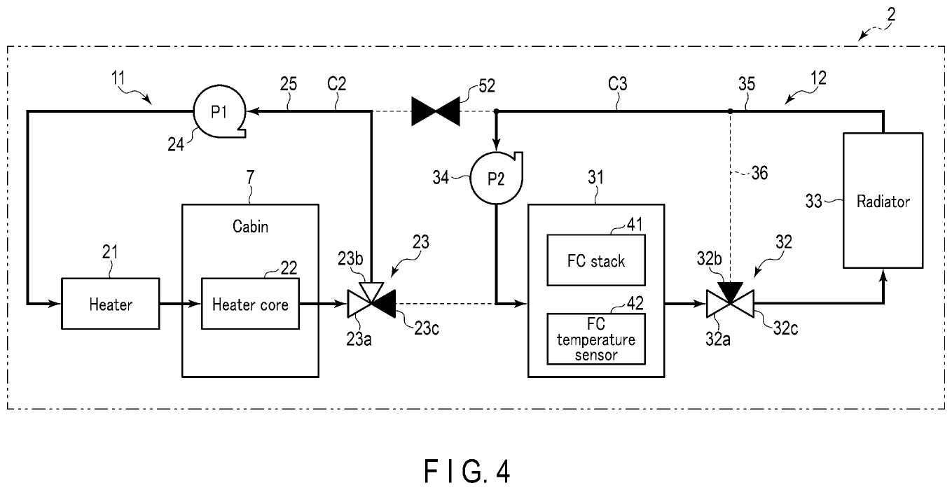

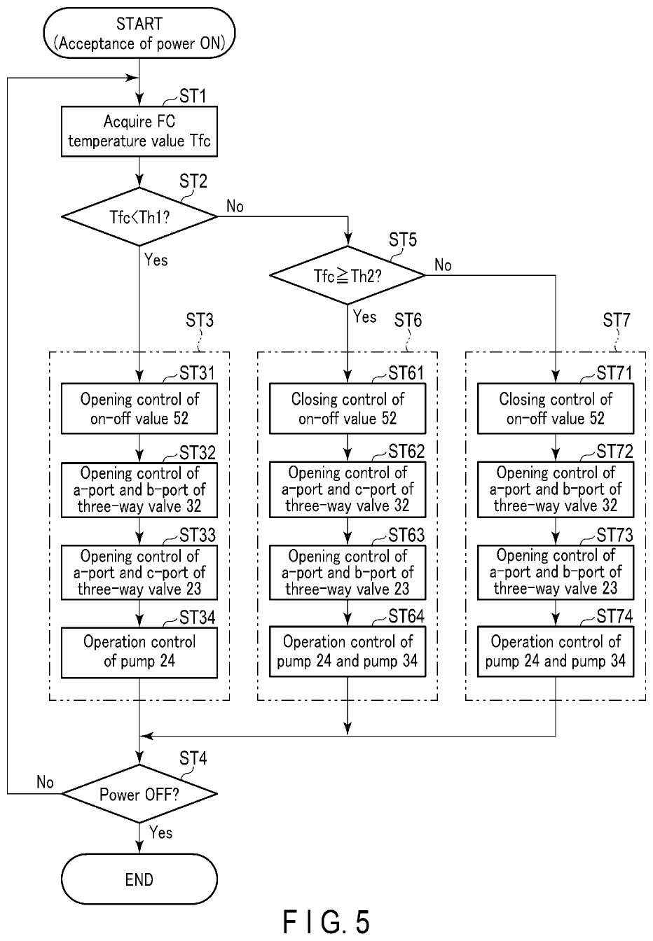

FIG. 1 is an explanatory diagram schematically illustrating a configuration of the fuel cell vehicle 1 according to the first embodiment of the present invention. FIG. 2 is a block diagram schematically illustrating a configuration of the fuel cell vehicle 1. FIG. 3 is an explanatory diagram illustrating a first control mode of the fluid control apparatus 2 used in the fuel cell vehicle 1, and FIG. 4 is an explanatory diagram illustrating a second control mode of the fluid control apparatus 2. FIG. 5 is a flowchart illustrating an example of control using the fluid control apparatus 2.

As illustrated in FIG. 1 and FIG. 2, the fuel cell vehicle 1 is an FCV (Fuel Cell Vehicle) in which electric power is generated by a fuel cell unit 31 by using hydrogen that is filled in a tank 15 at a hydrogen station 100 or the like, and oxygen that is taken in from outside air or the like. The fuel cell vehicle 1 drives and controls various structural elements by using the generated electric power. For example, the fuel cell vehicle 1 runs by driving a motor 14, and performs air-conditioning of a cabin (vehicle inside) 7 by driving an air-conditioning system 11. Note that fuel cell vehicles include a truck, a bus, a passenger car, a special-purpose vehicle, and the like. Hereinafter, a concrete example of the fuel cell vehicle 1 is described.

As illustrated in FIG. 1, the fuel cell vehicle 1 includes a chassis 3 and a vehicle body 4. The chassis 3 includes a frame and four or more wheels 5. In addition, as illustrated in FIG. 1 and FIG. 2, the fuel cell vehicle 1 includes the air-conditioning system 11, a fuel cell system 12, a battery 13, the motor 14, the tank 15, an outside air temperature sensor 16, and a control device 17.

In the fuel cell vehicle 1, the chassis 3 and vehicle body 4 are equipped with the air-conditioning system 11, fuel cell system 12, battery 13, motor 14, tank 15, outside air temperature sensor 16, and control device 17. In addition, the air-conditioning system 11, fuel cell system 12, outside air temperature sensor 16 and control device 17 constitute the fluid control apparatus 2.

The air-conditioning system 11 adjusts the temperature in the vehicle body 4 by heating air for air-conditioning of the vehicle body 4 and feeding heated air into the inside of the vehicle body 4 by a blower or the like. FIG. 2 is a block diagram schematically illustrating the configuration of main parts of fluid control apparatus 2 of the fuel cell vehicle 1. The air-conditioning system 11 includes, for example, a heater 21, a heater core 22, a three-way valve 23, a pump 24, and a circulating flow path 25. A medium flowing in the circulating flow path 25 of the air-conditioning system 11 is, for example, cooling water.

The heater 21 is, for example, an electric heater that heats cooling water. The heater core 22 is a heat exchanger for heating air of an air conditioner of the cabin 7 of the vehicle body 4.

The three-way valve 23 includes three ports 23a, 23b and 23c. The three-way valve 23 switches valve elements provided in the body thereof, thereby opening two of the three ports (port 23a, port 23b and port 23c) and fluidly connecting the two opened ports. In the present embodiment, among the three ports 23a, 23b and 23c of the three-way valve 23, the port 23a and port 23b are connected to the circulating flow path 25, and the port 23c is connected to a communicating flow path 51 (to be described later) that is connected to the fuel cell system 12. The three-way valve 23 is electrically connected to, for example, the control device 17, and switches two ports to be connected, based on a signal that is output from the control device 17.

The pump 24 press-feeds cooling water. The pump 24 is electrically connected to the control device 17, and is driven based on a driving signal that is output from the control device 17. The circulating flow path 25 connects the heater 21, heater core 22, ports 23a and 23b of the three-way valve 23, and pump 24. The circulating flow path 25 is a conduit forming a flow path in which the cooling water press-fed from the pump 24 passes through the heater 21, heater core 22, and port 23a and port 23b of the three-way valve 23 and returns to the pump 24. In this manner, the circulating flow path 25 circulates the cooling water press-fed from the pump 24 through the heater 21 and heater core 22.

The fuel cell system 12 includes the fuel cell unit 31, a three-way valve 32, a radiator 33, a pump 34, a circulating flow path 35, a bypass flow path 36, and a water temperature sensor (temperature sensor) 37. The fuel cell system 12 cools the fuel cell unit 31 by passing cooling water through the three-way valve 32, radiator 33, pump 34 and circulating flow path 35.

The fuel cell unit 31 includes a fuel cell stack (FC stack) 41 and an FC temperature sensor (temperature sensor) 42. The fuel cell stack 41 is, for example, a polymer electrolyte fuel cell. The fuel cell stack 41 has a stack structure in which a plurality of unit cells are stacked. Here, the unit cell includes, for example, a membrane electrode assembly (MEA) in which an electrolyte membrane formed of an ion exchange membrane, an air electrode formed on one surface of the electrolyte membrane, and a fuel electrode formed on the other surface of the electrolyte membrane are coupled. The MEA is formed by being sandwiched between a pair of separators. The fuel cell stack 41 generates electricity by supplying oxidation gas (oxygen) to the air electrode, and supplying fuel gas (hydrogen) to the fuel electrode.

The FC temperature sensor 42 detects the temperature of the fuel cell stack 41. The FC temperature sensor 42 is connected to the control device 17, and outputs a signal corresponding to the detected temperature to the control device 17.

The three-way valve 32 is provided on the downstream side of the fuel cell unit 31, and opens and closes the circulating flow path 35 on the downstream side of the fuel cell unit 31. The three-way valve 32 includes three ports 32a, 32b and 32c. The three-way valve 32 switches valve elements provided in the body thereof, thereby opening two of the three ports (port 32a, port 32b and port 32c) and fluidly connecting the two opened ports. In the present embodiment, among the three ports 32a, 32b and 32c of the three-way valve 32, the port 32a and port 32c are connected to the circulating flow path 35, and the port 32b is connected to the bypass flow path 36. The three-way valve 32 is electrically connected to, for example, the control device 17, and switches two ports to be connected, based on a signal that is output from the control device 17. Note that the three-way valve 32 may be formed to be capable of switching the three ports by a thermistor, and may be configured to connect the port 32a and port 32c in a case of a temperature that is equal to or higher than a predetermined temperature, and to connect the port 32a and port 32b in a case of a temperature that is lower than the predetermined temperature.

The radiator 33 is a heat exchanger. The radiator 33 cools cooling water by performing heat exchange between the cooling water passing through the inside thereof and a cooling wind.

The pump 34 press-feeds cooling water. The pump 34 is electrically connected to the control device 17, and is driven based on a driving signal that is output from the control device 17.

The circulating flow path 35 connects the fuel cell unit 31, port 32a and port 32c of the three-way valve 32, radiator 33, and pump 34. The circulating flow path 35 is a conduit forming a flow path in which the cooling water press-fed from the pump 34 passes through the fuel cell unit 31, port 32a and port 32c of the three-way valve 32 and radiator 33 and returns to the pump 34. In this manner, the circulating flow path 35 circulates the cooling water press-fed from the pump 34 through the fuel cell unit 31 and radiator 33.

The bypass flow path 36 is a conduit that fluidly connects the port 32b of the three-way valve 32 provided on the downstream side of the fuel cell unit 31 in the circulating flow path 35, and the downstream side of the radiator 33 that is also the upstream side of the pump 34 in the circulating flow path 35. The bypass flow path 36 forms a bypass between the fuel cell unit 31 and the pump 34, and returns the cooling water, which has passed through the fuel cell unit 31, to the pump 34 without through the radiator 33, at a time when the port 32a and port 32b of the three-way valve 32 are opened.

The water temperature sensor 37 detects the temperature of, for example, cooling water flowing through the circulating flow path 35, which is, as a concrete example, cooling water that has passed through the fuel cell unit 31. The water temperature sensor 37 is connected to the control device 17, and outputs a signal corresponding to the detected temperature to the control device 17.

In addition, the air-conditioning system 11 and the fuel cell system 12 include a communicating flow path 51 connecting the circulating flow path 25 and circulating flow path 35, and an on-off valve 52. The communicating flow path 51 includes, for example, a communicating flow path 51a and a communicating flow path 51b.

The communicating flow path 51a is a conduit that fluidly connects the downstream side of the radiator 33 of the circulating flow path 35, which is also the downstream side of the bypass flow path 36 and the upstream side of the pump 34, and the downstream side of the port 23b of the three-way valve 23 of the circulating flow path 25, which is also the upstream side of the pump 24.

The communicating flow path 51b is a conduit that fluidly connects the port 23c of the three-way valve 23 and the downstream side of the pump 34 of the circulating flow path 35, which is also the upstream side of the fuel cell unit 31.

The on-off valve 52 is provided on the communicating flow path 51a, and opens and closes the communicating flow path 51a. The on-off valve 52 is connected to the control device 17, and opens and closes the communicating flow path 51a, based on a signal that is output from the control device 17.

The air-conditioning system 11 and fuel cell system 12, which have the above-described structures, constitute a temperature-raising flow path (first flow path) C1 for raising the temperature of the fuel cell unit 31, a warming flow path (second flow path) C2 for air-conditioning, and a cooling flow path (third flow path) C3 for cooling the fuel cell unit 31, by controlling the three-way valve 23, three-way valve 32 and on-off valve 52. Note that in FIG. 3, the temperature-raising flow path C1, in which cooling water circulates, is indicated by a solid-line arrow, and in FIG. 4, the warming flow path C2 and cooling flow path C3, in which cooling water circulates, are indicated by solid-line arrows. In addition, in FIG. 3 and FIG. 4, flow paths, in which cooling water does not flow, or in which cooling water, even if flowing, does not circulate, are indicated by broken lines.

The temperature-raising flow path C1 is formed by a part of the circulating flow path 25, a part of the circulating flow path 35, the bypass flow path 36 and the communicating flow path 51. As illustrated in FIG. 3, the temperature-raising flow path C1 is a circulating flow path in which cooling water passes through the pump 24, heater 21, heater core 22, port 23a and port 23c of the three-way valve 23, fuel cell unit 31, port 32a and port 32b of the three-way valve 32, bypass flow path 36 and communicating flow path 51a, and returns to the pump 24. The on-off valve 52 is opened, the three-way valve 23 is switched to connect the port 23a and port 23c, the three-way valve 32 is switched to connect the port 32a and port 32b, and the pump 24 is driven, and thereby cooling water circulates in the temperature-raising flow path C1.

The warming flow path C2 is formed by the circulating flow path 25. The warming flow path C2 is a circulating flow path in which cooling water passes through the pump 24, heater 21, heater core 22, and port 23a and port 23b of the three-way valve 23, and returns to the pump 24. The three-way valve 23 is switched to connect the port 23a and port 23b, the on-off valve 52 is closed, and the pump 24 is driven, and thereby cooling water circulates in the warming flow path C2.

The cooling flow path C3 is formed by the circulating flow path 35. The cooling flow path C3 is a circulating flow path in which cooling water passes through the pump 34, fuel cell unit 31, port 32a and port 32c of the three-way valve 32, and radiator 33, and returns to the pump 34. The three-way valve 32 is switched to connect the port 32a and port 32c, the on-off valve 52 is closed, and the pump 34 is driven, and thereby cooling water circulates in the cooling flow path C3.

The battery 13 is a secondary battery. The battery 13 stores electric power generated by the fuel battery system 12. The battery 13 supplies power to the pump 24, pump 34, motor 14, control device 17 and various electrical equipment.

The motor 14 is connected to the control device 17, and is driven and controlled by the control device 17. The motor 14 drives the wheels 5 for running.

The tank 15 compresses and stores hydrogen.

The outside air temperature sensor (temperature sensor) 16 detects the temperature of outside air. The outside air temperature sensor 16 is connected to the control device 17, and outputs a signal corresponding to the detected temperature to the control device 17.

The control device 17 includes, for example, a power switch (power SW) 61, a GPS (Global Positioning System) sensor 62, an input interface 63, a memory 64, and a controller 65.

The power switch 61 is operated by a driver, and outputs information of the operation to the controller 65. Upon accepting an operation at a time when the fuel cell vehicle 1 is stopped, the power switch 61 outputs a signal to the controller 65 as acceptance of power ON. In addition, upon accepting an operation at a time when the fuel cell vehicle 1 is being driven, the power switch 61 outputs a signal to the controller 65 as acceptance of power OFF.

If the power switch 61 is operated and the power ON is accepted, the GPS sensor 62 acquires present position information of the fuel cell vehicle 1. The GPS sensor 62 outputs the acquired present position information to the controller 65.

The input interface 63 is an input device that inputs an instruction from an operator, for example, a driver. For example, the input interface 63 is input means such as a switch, a dial, a touch panel or the like, which is provided on an instrument panel or the like provided in the cabin 7.

The memory 64 is a storage medium. The memory 64 stores various control setting values and various control programs for controlling the fuel cell vehicle 1. In addition, the memory 64 stores information detected by various sensors including the water temperature sensor 37, FC temperature sensor 42 and outside air temperature sensor 16 as temperature sensors. Besides, the memory 64 stores various acquired information such as the amount of hydrogen used, the amount of taken-in oxygen, the amount of generated electricity in the fuel cell unit 31, and the amount of accumulated electricity and the used power in the battery 13.

The controller 65 is an arithmetic device. The controller 65 is, for example, an ECU (Electronic Control Unit). The controller 65 executes at least one of chassis control, motor control, headlight control, air-conditioning system control, fuel cell system control, brake system control, lane keeping system control, inter-vehicle distance control system control, car navigation control, and the like.

The controller 65 executes, for example, fluid control for controlling cooling water, as a part of the air-conditioning system control and fuel cell system control. Based on the temperature of the fuel cell unit 31, the controller 65 circulates cooling water by a first control mode and a second control mode, and executes control to raise the temperature of (i.e., to heat) the fuel cell unit 31 and to cool the fuel cell unit 31. In addition, based on the temperature of the fuel cell unit 31, the controller 65 may execute, by a third control mode, control to keep the temperature of the fuel cell unit 31.

Here, the first control mode is an operation control of raising the temperature of the fuel cell unit 31, this operation control being executed in a case where a temperature Tfc of the fuel cell unit 31 is lower than a threshold Th1 that is stored in the memory 64 and is a temperature requiring temperature raising of the fuel cell unit 31. For example, the first control mode is control that is executed at a time of starting the fuel cell vehicle 1 by the power switch 61. Here, the threshold Th1 is, for example, a temperature of the fuel cell unit 31, at which the power generation efficiency of the fuel cell unit 31 lowers.

Here, the temperature of the fuel cell unit 31 is, for example, the temperature of the fuel cell stack 41. The temperature Tfc of the fuel cell unit 31 may be a temperate value of the fuel cell stack 41, which is directly acquired by the FC temperature sensor 42, or a temperature value of cooling water acquired by the water temperature sensor 37 or an outside air temperature acquired by the outside air temperature sensor 16 may be estimated as the temperature of the fuel cell unit 31. In addition, the temperature Tfc of the fuel cell unit 31 may be acquired by one of the FC temperature sensor 42, the water temperature sensor 37 and the outside air temperature sensor 16, or may be acquired by some of or all of the FC temperature sensor 42, the water temperature sensor 37 and the outside air temperature sensor 16.

As illustrated in FIG. 3, the first control mode is an operation control of heating the fuel cell unit 31 by heated cooling water, by driving the pump 24, circulating cooling water through the temperature-raising flow path C1 and heating the cooling water by the heater 21.

The second control mode is an operation control of cooling the fuel cell unit 31, which is executed in a case where the temperature Tfc of the fuel cell unit 31 is equal to or greater than the threshold Th1. For example, the second control mode is executed in a case where the temperature Tfc of the fuel cell unit 31 is equal to or greater than the threshold Th1 and is equal to or greater than a threshold Th2 that is stored in the memory 64 and is a temperature requiring cooling of the fuel cell unit 31.

As illustrated in FIG. 4, the second control mode is an operation control in which the pump 34 is driven, cooling water is circulated in the fooling flow path C3, and the cooling water is cooled by the radiator 33, thereby cooling the fuel cell unit 31. In addition, as illustrated in FIG. 4, the second control mode is an operation control in which, for example, in addition to circulating cooling water in the cooling flow path C3, the pump 24 is driven, cooling water is circulated in the warming flow path C2, and the cooling water is heated by the heater 21.

The third control mode is executed in a case where the temperature Tfc of the fuel cell unit 31 is equal to or greater than the threshold Th1, and is less than the threshold Th2. The third control mode is an operation control in which the pump 34 is driven, and cooling water is circulated through the bypass flow path 36 without through the radiator 33, thereby keeping the temperature of the fuel cell unit 31 at a predetermined temperature. In addition, the third control mode may be configured to include, for example, a process of driving the pump 24, circulating cooling water in the warming flow path C2, and heating the cooling water by the heater 21.

Next, referring to FIG. 3 to FIG. 5, a description is given of an example of a fluid control method using the fluid control apparatus 2 of the fuel cell vehicle 1 with the above-described configuration. FIG. 3 is an explanatory diagram illustrating the first control mode of the fluid control apparatus 2. FIG. 4 is an explanatory diagram illustrating the second control mode of the fluid control apparatus 2. FIG. 5 is a flowchart illustrating an example of the fluid control method using the fluid control apparatus 2. Note that in FIG. 5, each of the ports 23a and 32a, each of ports 23b and 32b, and each of ports 23c and 32c of the three-way valve 23 and three-way valve 32 are described as “a-port”, “b-port”, and “c-port”, respectively.

If the driver operates the power switch 61 in the fuel cell vehicle 1 that is in the stopped state, the controller 65 accepts power ON and supplies electric power to each electrical equipment from the battery 13. Then, the controller 65 acquires the temperature value Tfc of the fuel cell stack 41 of the fuel cell unit 31 from the detection values by the water temperature sensor 37, FC temperature sensor 42 and/or outside air temperature sensor 16 (step ST1). The controller 65 compares the acquired temperature value Tfc of the fuel cell stack 41 with the threshold Th1, and determines whether the temperature value Tfc is less than the threshold Th1 (step ST2).

Specifically, the controller 65 functions as determination means and executes a determination process of determining whether the temperature of the fuel cell stack 41 is a low temperature that requires temperature raising.

If the temperature of the fuel cell stack 41 is a low temperature that requires temperature raising (Tfc<Th1) (YES in step ST2), the controller 65 controls the fluid control apparatus 2 in the first control mode (step ST3).

In a concrete example of the first control mode (step ST3), the controller 65 first executes control to open the on-off value 52 (step ST31), executes control to open the port 32a and port 32b of the three-way valve 32 (step ST32) and executes control to open the port 23a and port 23c of the three-way valve 23 (step ST33). Note that the switchings of the valves in steps ST31, ST32 and ST33 may be executed at the same time or successively.

Then, the controller 65 executes control to drive the pump 24 (step ST34), and the cooling water is heated by the heater 21. Thereby, the cooling water is heated by the heater 21, and, as illustrated in FIG. 3, the cooling water circulates in the temperature-raising flow path (first flow path) C1, heat exchange is performed between the heated cooling water and the fuel cell stack 41 of the fuel cell unit 31, and the temperature of the fuel cell stack 41 is raised.

By the first control mode, the controller 65 controls the fluid control apparatus 2, and monitors the operation of the power switch 61 (step ST4). If the power switch 61 is operated and power OFF is accepted (YES in step ST4), the controller 65 stops the supply of electric power to the electrical equipment, and stops the driving of the fuel cell vehicle 1. If the power switch 61 is not operated (NO in step ST4), the controller 65 returns to step ST1.

In step ST2, if the temperature of the fuel cell stack 41 is not a low temperature that requires temperature raising (Tfc≥Th1) (NO in step ST2), the controller 65 compares the acquired temperature value Tfc of the fuel cell stack 41 with the threshold Th2, and determines whether the temperature value Tfc is equal to or greater than the threshold Th2 (step ST5). Specifically, the controller 65 executes a determination process of determining whether the temperature of the fuel cell stack 41 is a high temperature that requires cooling.

If the temperature of the fuel cell stack 41 is a high temperature that requires cooling (Tfc≥Th2) (YES in step ST5), the controller 65 controls the fluid control apparatus 2 in the second control mode (step ST6).

In a concrete example of the second control mode, the controller 65 first executes control to close the on-off value 52 (step ST61), executes control to open the port 32a and port 32c of the three-way valve 32 (step ST62) and executes control to open the port 23a and port 23b of the three-way valve 23 (step ST63). Note that the switchings of the valves in steps ST61, ST62 and ST63 may be executed at the same time or successively.

Then, the controller 65 executes control to drive the pump 24 and the pump 34 (step ST64), to heat the cooling water flowing in the warming flow path (second flow path) C2 by the heater 21, and to cool the cooling water flowing in the cooling flow path (third flow path) C3 by the radiator 33. Heat exchange is performed between the cooling water flowing in the cooling flow path C3 and the fuel cell stack 41, and thereby the fuel cell stack 41 is cooled, and the cooling water heated by the fuel cell stack 41 undergoes heat exchange in the radiator 33 and is cooled. In this manner, in the second control mode, as illustrated in FIG. 4, the cooling water circulates in the warming flow path C2, and thereby the cabin 7 can be warmed by the heater core 22, and the fuel cell stack 41 is cooled.

Note that the second control mode may be configured such that, for example, under a predetermined condition such as a case where the outside air temperature is high, the heater 21 is not driven and the cooling water flowing in the warming flow path C2 is not heated by the heater 21, or neither the pump 24 nor the heater 21 is driven.

By the second control mode, the controller 65 controls the structural elements of the fluid control apparatus 2, and monitors the operation of the power switch 61 (step ST4). If the power switch 61 is operated and power OFF is accepted, the controller 65 stops the supply of electric power to the electrical equipment, and stops the driving of the fuel cell vehicle 1. If the power switch 61 is not operated, the controller 65 returns to step ST1.

In step ST5, if the temperature of the fuel cell stack 41 is not a high temperature that requires cooling (Tfc<Th2) (NO in step ST5), the controller 65 controls the fluid control apparatus 2 in the third control mode (step ST7).

In a concrete example of the third control mode, the controller 65 first executes control to close the on-off value 52 (step ST71), executes control to open the port 32a and port 32b of the three-way valve 32 (step ST72) and executes control to open the port 23a and port 23b of the three-way valve 23 (step ST73). Note that the switchings of the valves in steps ST71, ST72 and ST73 may be executed at the same time or successively.

Then, the controller 65 executes control to drive the pump 24 and the pump 34 (step ST74), to heat the cooling water flowing in the warming flow path (second flow path) C2 by the heater 21, and to pass the cooling water flowing in the cooling flow path (third flow path) C3 through the bypass flow path 36 without through the radiator 33. Thereby, although the cooling water flowing in the cooling flow path C3 undergoes heat exchange with the fuel cell stack 41, the cooling water is not cooled by the radiator 33. Hence, the fuel cell stack 41 is not cooled, and the temperature of the fuel cell stack 41 is kept. In this manner, in the third control mode, the cooling water circulates in the warming flow path (second flow path) C2, and thereby the cabin 7 can be warmed by the heater core 22, and the fuel cell stack 41 is not cooled. Note that the third control mode may be configured such that, for example, under a predetermined condition such as a case where the outside air temperature is high, the heater 21 is not driven and the cooling water flowing in the warming flow path C2 is not heated by the heater 21, or neither the pump 24 nor the heater 21 is driven.

In addition, by the third control mode, the controller 65 controls the structural elements of the fluid control apparatus 2, and monitors the operation of the power switch 61 (step ST4). If the power switch 61 is operated and power OFF is accepted, the controller 65 stops the supply of electric power to the electrical equipment, and stops the driving of the fuel cell vehicle 1. If the power switch 61 is not operated, the controller 65 returns to step ST1.

In this manner, the controller 65 functions as the control means, and executes the control process of the fluid control apparatus 2 in one of the first control mode, second control mode and third control mode until the power OFF is accepted by the operation of the power switch 61.

According to the fuel cell vehicle 1 and fluid control apparatus 2 with the above-described configuration, in the low-temperature environment in which the power generation efficiency of the fuel cell unit 31 lowers, the cooling water heated by the heater 21 heats the fuel cell unit 31 in the first control mode. In this manner, the fuel cell unit 31 can raise the temperature of the fuel cell stack 41 by performing heat exchange with the cooling water heated by the heater 21, and not by raising the temperature by the generated heat of the fuel cell stack 41 at the time of power generation. Thus, the fluid control apparatus 2 does not increase the consumption amount of hydrogen, and can set the temperature of the fuel cell stack 41 within a predetermined range in which a high power generation efficiency can be attained. Since the fuel cell vehicle 1 can suppress or hold down the consumption amount of hydrogen in the fuel cell stack 41, the fuel cell vehicle 1 can prevent the driving range from becoming shorter.

Additionally, in the fuel cell vehicle 1 and fluid control apparatus 2, the circulating flow path 25 and circulating flow path 35 are connected by the communicating flow path 51, and the temperature of the fuel cell stack 41 is raised by the heater 21 used for the air-conditioning system 11. Thus, there is no need to provide the fuel cell system 12 with a heater for raising the temperature of the fuel cell stack 41. In addition, in the first control mode, by opening the port 32a and port 32b of the three-way valve 32, the cooling water, which has been heated by the heater 21 and has been heat-exchanged with the fuel cell stack 41, returns to the heater 21 through the bypass flow path 36, without through the radiator 33. Thus, since the cooling water that heats the fuel cell stack 41 is not cooled by the radiator 33, the temperature of the cooling water that heats the fuel cell stack 41 can be prevented from lowering, and therefore the power consumption of the heater 21 can be held down or suppressed and the temperature-raising efficiency of the FC stack 41 can be improved.

Additionally, in the second control mode, the warming flow path (second flow path) C2 functioning as a system for heating the cabin 7 by the heater 21 and heater core 22, and the cooling flow path (third flow path) C3 functioning as a system for cooling the fuel cell stack 41 by using the radiator 33, are configured to be fluidly independent from each other. Thereby, in the second control mode, in each of the systems, the temperature can be controlled with high precision.

As described above, according to the fuel cell vehicle 1 and fluid control apparatus 2 relating to the first embodiment, the consumption of hydrogen of the fuel cell unit 31 that uses hydrogen as fuel can be held down or suppressed, and the temperature of the fuel cell unit 31 can be raised up to a predetermined temperature range.

Note that the present invention is not limited to the above-described first embodiment. For example, in the above example, the configuration was described in which the temperature Tfc of the fuel cell unit 31, which the fuel cell vehicle 1 (fluid control apparatus 2) determines in order to execute the first control mode, is acquired by at least one of the FC temperature sensor 42, water temperature sensor 37 and outside air temperature sensor 16. However, as regards the temperature Tfc of the fuel cell unit 31, in addition to the FC temperature sensor 42, water temperature sensor 37 and outside air temperature sensor 16 or in place of the FC temperature sensor 42, water temperature sensor 37 and outside air temperature sensor 16, with use of position information acquired from the GPS sensor 62 or by a calendar function or a clock function of the controller 65, an environmental temperature of the fuel cell vehicle 1 may be estimated, and whether or not to execute the first control mode may be determined by using the estimated environmental temperature as the temperature Tfc of the fuel cell unit 31. Furthermore, the first control mode may be configured to be executable in accordance with an instruction that is input by the user from the input interface 63. Besides, the fuel cell vehicle 1 may include a wireless communication device, may acquire an environmental temperature or the like from an outside, such as a user's mobile terminal, through the wireless communication device, and may determine whether or not to execute the first control mode, based on the acquired environmental temperature.

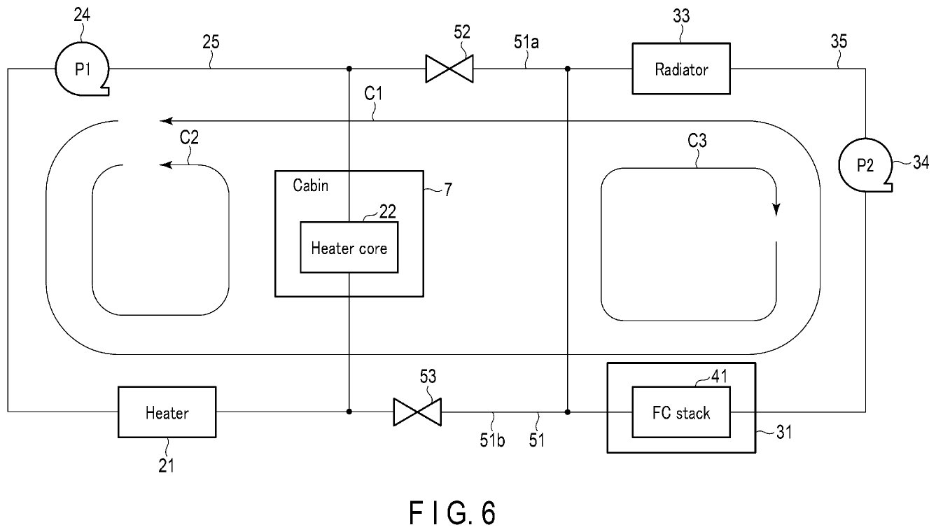

Additionally, the temperature-raising flow path C1, which is formed by the flow path (circulating flow path 25) of the air-conditioning system 11 of the fluid control apparatus 2 and the flow path (circulating flow path 35) of the fuel cell system 12, is not limited to the above-described example. Specifically, although the above-described temperature-raising flow path C1 was described as being formed by the three-way valve 23, three-way valve 32 and on-off valve 52, the temperature-raising flow path C1 is not limited to this configuration. For example, as illustrated in FIG. 6, such a configuration may be adopted that, without the three-way valve 23 and three-way valve 32 being provided, the temperature-raising flow path C1 is formed by a plurality of on-off valves and a bypass flow path.

For instance, in an example of a fuel cell vehicle 1 (fluid control apparatus 2) of a second embodiment illustrated in FIG. 6, a communicating flow path 51 connects the upstream side and downstream side of the heater core 22 of the circulating flow path 25 and a flow path between the FC stack 41 and radiator 33 of the circulating flow path 35 by a communicating flow path 51a and a communicating flow path 51b. The fuel cell vehicle 1 (fluid control apparatus 2) includes an on-off valve 53 on the communicating flow path 51b, in addition to the on-off valve 52 provided on the communicating flow path 51a. In the first control mode, the controller 65 opens the on-off valve 52 and on-off valve 53 and drives the pump 24, thereby forming the temperature-raising flow path C1 in which the cooling water circulates through the heater 21, fuel cell unit 31 and radiator 33, and executes the operation control in the first control mode of raising the temperature of the fuel cell unit 31 by the temperature-raising flow path C1. In addition, in the second control mode, the controller 65 closes the on-off valve 52 and on-off valve 53, drives the pump 24 and pump 34, and circulates the cooling water in the warming flow path C2 and cooling flow path C3.

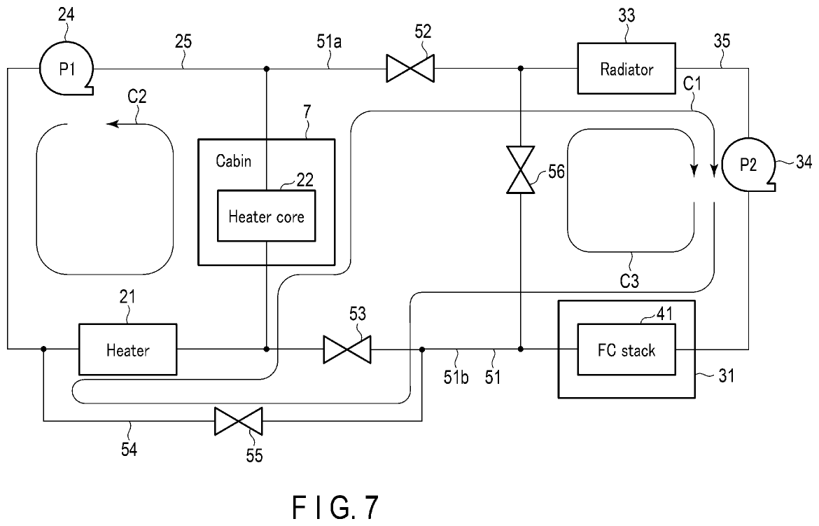

Additionally, for instance, in an example of a fuel cell vehicle 1 (fluid control apparatus 2) of a third embodiment illustrated in FIG. 7, a communicating flow path 51 connects the upstream side and downstream side of the heater core 22 of the circulating flow path 25 and a flow path between the FC stack 41 and radiator 33 of the circulating flow path 35 by a communicating flow path 51a and a communicating flow path 51b. The fuel cell vehicle 1 (fluid control apparatus 2) includes an on-off valve 53 provided on the communicating flow path 51b; a bypass flow path 54 that forms a bypass between the upstream side of the heater 21 and the on-off valve 53; an on-off valve 55 provided on the bypass flow path 54; and an on-off valve 56 provided between the fuel cell unit 31 and the radiator 33.

In the first control mode, the controller 65 closes the on-off valve 53 and on-off valve 56, and opens the on-off valve 52 and on-off valve 55. Thereby, the controller 65 forms a temperature-raising flow path C1 in which cooling water circulates through the fuel cell unit 31, bypass flow path 54, heater 21, heater core 22, and radiator 33, and executes operation control in the first control mode in which the temperature of the fuel cell unit 31 is raised by the temperature-raising flow path C1. In addition, in the second control mode, the controller 65 closes the on-off valve 52, on-off valve 53 and on-off valve 55, opens the on-off valve 56, and drives the pump 24 and pump 34, thereby circulating cooling water in the warming flow path C2 and the cooling flow path C3.

Specifically, as illustrated in these different embodiments, the fuel cell vehicle 1 and fluid control apparatus 2 may be configured to circulate, in the first control mode, cooling water, which raises the temperature of the FC stack 41, through the radiator 33. As illustrated in the above embodiments, the first control mode is appropriately settable if the first control mode is configured such that the circulating flow path 25 of the air-conditioning system 11 and the circulating flow path 35 of the fuel cell system 12 are selectively connected, and the fuel cell unit 31 can be heated (i.e., the temperature of the fuel cell unit 31 can be raised) by the cooling water heated by the heater 21 of the air-conditioning system 11. However, in order to suppress unnecessary cooling of the cooling water heated in order to raise the temperature of the FC stack 41, such a configuration is preferable that cooling water does not pass through the radiator 33 in the temperature-raising flow path C1.

Additionally, in the above-described examples, the configuration was described in which the control process of the circulation of cooling water controlled by the controller 65 of the fuel cell vehicle 1 (fluid control apparatus 2) includes the first control mode, second control mode and third control mode, but the configuration is not limited to this. For example, such a configuration may be adopted that the fuel cell vehicle 1 (fluid control apparatus 2) does not include the third control mode, and executes the control process of circulating cooling water by the first control mode and the second control mode, or such a configuration may be adopted that the fuel cell vehicle 1 (fluid control apparatus 2) includes a control mode other than the first control mode, second control mode and third control mode.

Additionally, in the above-described examples, the configuration was described in which in the second control mode, cooling water is circulated in the warming flow path C2 and the cooling water in the warming flow path C2 is heated by the heater 21, and cooling water is circulated in the cooling flow path C3 and the cooling water is cooled by the radiator 33. However, in the second control mode, such a configuration may be adopted that only the cooling of the fuel cell unit 31 is performed by circulating cooling water in the cooling flow path C3, and that cooling water, which is circulated in the warming flow path C2, is not heated by the heater 21, or cooling water is not circulated in the warming flow path C2. In this case, such a configuration may be adopted that, in another control mode, upon the user's operation of the input interface 63 such as a panel for air-conditioning, or based on the outside air temperature, an operation control is executed to drive the pump 24, to circulate cooling water in the warming flow path C2 and to heat the cooling water by the heater 21.

The present invention is not limited to the above-described embodiments. At the stage of practicing the invention, various modifications may be made without departing from the spirit of the invention. In addition, the embodiments may properly be combined and practiced, and advantageous effects by the combinations can be obtained. Further, the embodiments include various invention, and various inventions may be derived by properly combining structural elements selected from the disclosed structural elements. For example, even if some structural elements are omitted from all the structural elements disclosed in the embodiments, structures from which these structural elements are omitted may be derived as inventions in the case where the problem can be solved and the advantageous effects can be obtained.

### REFERENCE SIGNS LIST

1 . . . Fuel cell vehicle, 2 . . . Fluid control apparatus, 3 . . . Chassis, 4 . . . Vehicle body, 5 . . . Wheels, 7 . . . Cabin (vehicle inside), 11 . . . Air-conditioning system, 12 . . . Fuel cell system, 13 . . . Battery, 14 . . . Motor, 15 . . . Tank, 16 . . . Outside air temperature sensor (temperature sensor), 17 . . . Control device, 21 . . . Heater, 22 . . . Heater core, 23 . . . Three-way valve, 23a . . . Port, 23b . . . Port, 23c . . . Port, 24 . . . Pump, 25 . . . Circulating flow path, 31 . . . Fuel cell unit, 32 . . . Three-way valve, 32a . . . Port, 32b . . . Port, 32c . . . Port, 33 . . . Radiator, 34 . . . Pump, 35 . . . Circulating flow path, 36 . . . Bypass flow path, 37 . . . Water temperature sensor (temperature sensor), 41 . . . Fuel cell stack (FC stack), 42 . . . FC temperature sensor (temperature sensor), 51 . . . Communicating flow path, 51a . . . Communicating flow path, 51b . . . Communicating flow path, 52 . . . On-off valve, 53 . . . On-off valve, 54 . . . Bypass flow path, 55 . . . On-off valve, 56 . . . On-off valve, 61 . . . Power switch (power SW), 62 . . . GPS sensor, 63 . . . Input interface, 64 . . . Memory, 65 . . . Controller, 100 . . . Hydrogen station, C1 . . . Temperature-raising flow path (first flow path), C2 . . . Warming flow path (second flow path), and C3 . . . Cooling flow path (third flow path).

What is claimed is:

1. A fluid control apparatus comprising:
a heater configured to heat cooling water;
a heater core configured to be heated by the cooling water that is heated by the heater;
a fuel cell unit including a fuel cell;
a radiator configured to perform heat exchange with the cooling water; and
a controller configured to control circulation of the cooling water in one of a plurality of control modes, the control modes including a first control mode in which the cooling water heated by the heater circulates in a first flow path in which the cooling water passes through the heater, the hater core and the fuel cell unit and circulates, and a second control mode in which the cooling water is circulated in each of a second flow path in which the cooling water passes through the heater and the heater core and circulates, and a third flow path in which the cooling water passes through the fuel cell unit and the radiator and circulates, the third flow path being independent from the second flow path.

2. The fluid control apparatus of claim 1, wherein the first flow path does not pass through the radiator.

3. The fluid control apparatus of claim 1, wherein the controller is configured to execute a determination process of determining whether a temperature of the fuel cell unit is less than a threshold that is a temperature value lower than a temperature at which a power generation efficiency of the fuel cell unit lowers, and to execute a control process in the first control mode if the controller determines that the temperature of the fuel cell unit is less than the threshold.

4. The fluid control apparatus of claim 3, further comprising a temperature sensor configured to detect the temperature of the fuel cell unit,
wherein the controller is configured to execute the determination process, based on the temperature of the fuel cell unit detected by the temperature sensor.

5. The fluid control apparatus of claim 3, further comprising a temperature sensor configured to detect a temperature of the cooling water circulating in the third flow path,
wherein the controller is configured to execute the determination process by using the temperature detected by the temperature sensor as the temperature of the fuel cell unit.

6. The fluid control apparatus of claim 3, further comprising a temperature sensor configured to detect an outside air temperature,
wherein the controller is configured to execute the determination process by using the temperature detected by the temperature sensor as the temperature of the fuel cell unit.

7. The fluid control apparatus of claim 3, wherein the controller is configured to execute the control process in the second control mode if the controller determines that the temperature of the fuel cell unit is equal to or greater than the threshold.

8. A fuel cell vehicle comprising the fluid control apparatus of claim 1.

9. A fuel cell vehicle comprising the fluid control apparatus of claim 2.

10. A fuel cell vehicle comprising the fluid control apparatus of claim 3.

11. A fuel cell vehicle comprising the fluid control apparatus of claim 4.

12. A fuel cell vehicle comprising the fluid control apparatus of claim 5.

13. A fuel cell vehicle comprising the fluid control apparatus of claim 6.

14. A fuel cell vehicle comprising the fluid control apparatus of claim 7.

15. A fluid control method of a fluid control apparatus comprising a heater configured to heat cooling water, a heater core configured to be heated by the cooling water that is heated by the heater, a fuel cell unit including a fuel cell, and a radiator configured to perform heat exchange with the cooling water, the fluid control method comprising:
selecting one of a plurality of control modes, the control modes including a first control mode in which the cooling water heated by the heater circulates in a first flow path in which the cooling water passes through the heater, the hater core and the fuel cell unit and circulates, and a second control mode in which the cooling water is circulated in each of a second flow path in which the cooling water passes through the heater and the heater core and circulates, and a third flow path in which the cooling water passes through the fuel cell unit and the radiator and circulates, the third flow path being independent from the second flow path; and
executing a control process of circulation of the cooling water in the selected control mode.
